(19) United States
(12) Patent Application Publication
(10) Pub. No.: US 2007/0254674 A1
(43) Pub. Date: Nov. 1, 2007

(54) Location Determination With A Wireless System

(75) Inventors: Madison F. Pedigo, Allen, TX (US); Carl M. Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments, Inc., Dallas, TX (US)

(21) Appl. No.: 11/380,856

(22) Filed: Apr. 28, 2006

(51) Int. Cl. H04Q 7/20

(52) U.S. Cl. 455/456.2

(57) ABSTRACT

A mobile device comprises host logic and a first transceiver coupled to the host logic. The first transceiver is adapted to wirelessly communicate with a second transceiver. The second transceiver is positioned at a fixed location and comprises location information indicative of such fixed location. The first transceiver transmits wireless beacon signals. When the second transceiver is within range of the first transceiver, the beacon signal automatically causes the second transceiver to transmit the location information to the first transceiver.

### CROSS-REFERENCE TO RELATED APPLICATIONS

This application relates to the following commonly assigned co-pending application entitled. “Assisting A Location-Determining System Using Location Determined From A Communication System,” Ser. No. ______, filed ______, Attorney Docket No. TI-60798 (1962-28700); of which is incorporated by reference herein

### BACKGROUND OF THE INVENTION

1. Technical Field

The present disclosure relates generally to determining the location of a mobile device. More specifically, the present disclosure relates to determining the location of a mobile device using radio frequency identification (RFID) techniques.

2. Background Information

By definition, a mobile device can be moved from one location to another. The device determining or being informed of its location is desirable for various reasons. Improved systems and methods for determining the location of a mobile device are desirable.

### BRIEF SUMMARY

In general, apparatus and methods are described herein in which one or more transceivers are positioned at fixed and known locations. Each transceiver has access to location information which specifies the location of that transceiver. A mobile device can, when such mobile device is within communication range of a fixed-location transceiver, cause the transceiver to wirelessly report its location to the mobile device. At that point, the mobile device knows its own location to be within the communication range of the transceiver. In some embodiments, the mobile device and transceiver are radio frequency identification (RFID)-compliant.

In accordance with at least some embodiments, a mobile device comprises host logic and a first transceiver coupled to the host logic. The first transceiver is adapted to wirelessly communicate with a second transceiver. The second transceiver is positioned at a fixed location and comprises location information indicative of such fixed location. The first transceiver transmits wireless beacon signals. When the second transceiver is within range of the first transceiver, the beacon signal automatically causes the second transceiver to transmit the location information to the first transceiver.

In accordance with another embodiment, a mobile device comprises host logic and a first transceiver coupled to the host logic. The first transceiver is adapted to wirelessly communicate with a second transceiver. The second transceiver is positioned at a fixed location and comprises location information indicative of such fixed location. The first transceiver receives a wireless beacon signal transmitted by the second transceiver. The beacon signal causes the first transceiver to transmit a second signal to the second transceiver. The first transceiver receives a response signal from the second transceiver that contains the location information.

In accordance with yet another embodiment, a communication device comprises a transceiver and storage comprising location information indicative of the location of the communication device. Upon receiving a wireless signal from a mobile wireless device, the transceiver responds by automatically transmitting its location to said mobile wireless device.

In accordance with yet another embodiment, a disclosed method embodiment comprises various actions. The method comprises detecting a wireless signal and, upon detecting the wireless signal, automatically retrieving a location of a fixed position wireless communication device and transmitting the location to a mobile wireless communication device.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a system in accordance with preferred embodiments of the invention; and

FIG. 2 shows a method in accordance with embodiments of the invention.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

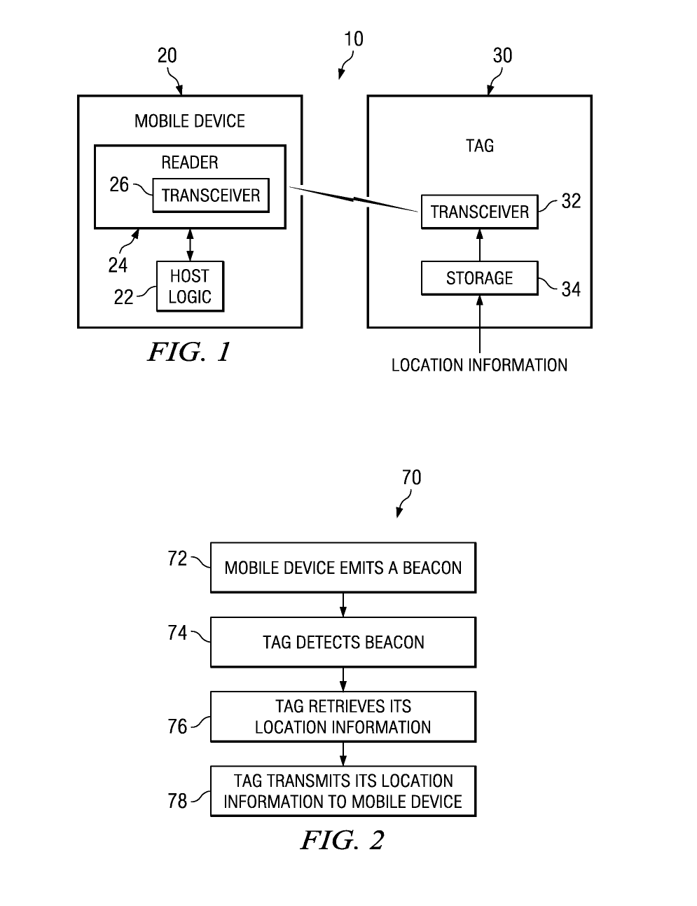

FIG. 1 shows a system 10 in accordance with preferred embodiments of the invention. The system 10 preferably comprises one or more wireless communication devices such as a mobile device 20 and a “tag” 30. The mobile device 20 comprises host logic 22 and a reader 24 which, in turn, comprises a transceiver 26. The tag 30 comprises a transceiver 32 and storage 34. If desired, other components may be included with the mobile device 20 and tag 30.

The mobile device 20 may comprise any of a variety of mobile devices such as cellular telephones, personal data assistants (PDAs), computers, etc. The host logic 22 performs one or more functions associated with the general functionality of the mobile device. For example, in the case of a cellular telephone, the host logic 22 may comprise a radio (preferably separate and apart from the transceiver 26), a keypad, a display, and control logic (e.g., a processor) to control the operation of the cellular telephone. In the case of a PDA or computer, the host logic 22 comprises a processor, memory, and other components typical of such devices.

Via the transceivers 26 and 32, the mobile device 20 and tag 30 wirelessly communicate with each other. In accordance with one embodiment of the invention, the reader 24 of the mobile device and the tag 30 are provided in accordance with the radio frequency identification (RFID) protocol. As such, the reader 24 comprises an RFID reader and the tag 30 comprises an RFID tag. Unless otherwise specified, as used herein, the term “tag” is not limited to the RFID context. The tag 30 preferably is positioned at a fixed location such as on a wall, furniture, or piece of equipments. In other embodiments, the mobile device 20 comprises a tag and the system 10 comprises a reader that is positioned at a fixed location. Other embodiments comprise wirelessly devices other than RFID-based devices. For example, the mobile device 20 may comprise an ultra wide band (UWB) transceiver which wirelessly communicates with another UWB transceiver positioned at a fixed location.

As explained above, the tag 30 is positioned at a fixed and known locations. The location of the tag can be denoted in accordance with a variety of techniques such as longitude and latitude coordinates, relative location to another known location, etc. Location information indicative of the location of the tag 30 is stored in the tag's storage 34. The storage may comprise any suitable type of storage medium such as random access memory (RAM), flash memory, electrically erasable read-only memory (EEPROM), etc., and/or combinations thereof. The location information indicative of the tag's location is loaded into storage 34 in accordance with any of a variety of techniques. For example, the location information can be wirelessly transmitted to the tag's transceiver 32 from a programming device (not specifically shown).

In accordance with embodiments in which the mobile device 20 and tag 30 are RFID-compliant, the reader 24 emits a periodic wireless beacon signal that, when in range of transceiver 32 causes the tag 30 to automatically echo back a wireless response signal along with an identifier associated with the tag. In at least some embodiments, the identifier differentiates the tag 30 from other tags. Upon receipt of the response signal, the mobile device 20 is able to determine that the mobile device is within range of the tag 30. The tag 30 also retrieves its location information from storage 34 and transmits the location information to the mobile device's reader 24. The location information can be transmitted within the response signal or as part of a separate wireless transmission. Moreover, the beacon signal emitted by the reader 24 automatically causes the tag's transceiver 32 to transmit the tag's location information to the reader's transceiver 26. The beacon signal may be automatically emitted at predetermined fixed or programmable periodic intervals. Additionally or alternatively, the mobile device 20 can be manually activated by its user to emit a beacon.

In some embodiments, the tag 30 is passive (i.e., the tag does not have its own source of power) and in other embodiments, the tag is active (i.e., has its own source of power). In accordance with at least some embodiments, the range at which the mobile device 20 and tag 30 can engage in effective communications depends on whether the tag is passive or active as well as one or more other factors such as the communication frequency, the transmit power, etc. In embodiments in which the tag is passive, communications are limited to less than about 3 meters and in some embodiments 2 feet or less, while if the tag is active, communications are limited to less than about 200 feet. In either case, once the mobile device 20 has been informed of the location of the tag 30, the location of the mobile device 20 is then known, estimated, or inferred, at least within the effective communication range of the tags. For example, if the effective communication range is 3 meters or less, then the mobile device knows its location to be within 3 meters of the location of the tag.

The mobile device 20 (e.g., the host logic 22) determines the type of tag (e.g., passive or active) to which it communicates Based on the tag type, the mobile device 20 infers or estimates its location based on the received tag's location information. In some embodiments, the mobile device's host logic 22 and/or reader 24 determines the type of tag to which it communicates based on, for example, an aspect of the communication transmission (e.g., frequency), while in other embodiments, the mobile device can only communicate with one type of tag (active or passive). In this latter embodiment, the host logic and/or reader inherently knows the mobile device is communicating with a particular type of tag and thus its location range from the tag's position. Further still, in those embodiments in which the mobile device comprises the tag, the host logic knows that the mobile device has a particular type tag and thus can estimate its location accordingly.

In some embodiments, Near Field Communication (NFC) Transceivers and Tags can be used. NFC transceivers and tags operate at relatively short range. Such devices can function as either transceivers (active mode) or passive tags with an on-demand response. An on-demand response refers to a passive mode in which one device generates the RF field while the other device uses load modulation to transfer the data. NFC-enabled devices are generally interoperable with contactless smart-cards and smart-card readers conforming to these protocols. The effective communication range for NFC-based devices is generally less than about 1 foot and in some embodiments less than about 8 inches.

Communication is terminated either by a command from the application or when devices move out of range. In accordance with such embodiments, a user of an NFC-enabled mobile device could move his mobile device (e.g., cellular telephone) in proximity of an NFC transceiver or tag, for example, to purposely sync his or her position or this might happen automatically as he or she is purchasing an item at a store.

FIG. 2 illustrates a corresponding method 70. At 72, the mobile device emits a beacon signal. The beacon signal is detected by the tag at 74. In some embodiments, such as those described above, the beacon signal cannot be detected by the tag until the mobile device is within range (e.g., within 3 meters, 200 feet, or 1 foot as noted above) of the tag. The tag retrieves its location information at 76 and transmits its location information to the mobile device 20 at 78.

While the preferred embodiments of the present invention have been shown and described, modifications thereof can be made by one skilled in the art without departing from the spirit and teachings of the invention. For example, the communication between the communication device and tag/reader can be infra-red (IR)-based instead of radio frequency (RF)-based as in the case of RFID. The scope of protection is not limited by the description set out above. Each and every claim is incorporated into the specification as an embodiment of the present invention.

What is claimed is:

1. A mobile device, comprising:
host logic; and
a first transceiver coupled to said host logic and adapted to wirelessly communicate with a second transceiver, said second transceiver positioned at a fixed location and comprising location information indicative of said fixed location;
wherein said first transceiver transmits a wireless signal and, when the second transceiver is within range of the first transceiver, said wireless signal automatically causes the second transceiver to transmit said location information to the first transceiver.

2. The mobile device of claim 1 wherein said mobile device comprises a radio frequency identification (RFID) reader that comprises said first transceiver.

3. The mobile device of claim 1 wherein said mobile device comprises a near field communication device that comprises said first transceiver.

4. The mobile device of claim 1 wherein a range of communications between said first and second transceivers is less than about 3 meters.

5. The mobile device of claim 1 wherein a range of communications between said first and second transceivers is less than about 200 feet.

6. The mobile device of claim 1 wherein a range of communications between said first and second transceivers is less than about 1 foot.

7. The mobile device of claim 1 wherein said wireless signal also causes said second transceiver to transmit an identifier of said second transceiver.

8. The mobile device of claim 1 wherein said wireless signal comprises a beacon signal.

9. The mobile device of claim 1 wherein said host logic estimates a location for said mobile device based on the location information.

10. The mobile device of claim 1 wherein said second transceiver having one of a plurality of types and said host logic estimates a location for said mobile device based on the location information and the type of said second transceiver.

11. A mobile device, comprising:
host logic; and
a first transceiver coupled to said host logic and adapted to wirelessly communicate with a second transceiver, said second transceiver positioned at a fixed location and comprising location information indicative of said fixed location;
wherein said first transceiver receives a wireless signal transmitted by said second transceiver and said wireless signal causes the first transceiver to transmit a second signal to the second transceiver, and said first transceiver receives a response signal from the second transceiver that contains said location information.

12. The mobile device of claim 11 wherein said mobile device comprises a radio frequency identification (RFID) tag that comprises said first transceiver.

13. The mobile device of claim 11 wherein a range of communications between said first and second transceivers is less than about 3 meters.

14. The mobile device of claim 11 wherein a range of communications between said first and second transceivers is less than about 200 feet.

15. The mobile device of claim 11 wherein a range of communications between said first and second transceivers is less than about 1 foot.

16. The mobile device of claim 11 wherein said wireless signal comprises a beacon signal.

17. The mobile device of claim 11 wherein said host logic estimates a location for said mobile device based on the location information.

18. A communication device, comprising:
a transceiver; and
storage comprising location information indicative of the location of the communication device;
wherein, upon receiving a wireless signal from a mobile wireless device, said transceiver responds by transmitting its location to said mobile wireless device.

19. The communication device of claim 18 wherein a range of communication between the communication device and the mobile wireless device is less than about 3 meters.

20. The communication device of claim 18 wherein a range of communication between the communication device and the mobile wireless device is less than about 200 feet.

21. The communication device of claim 18 wherein a range of communication between the communication device and the mobile wireless device is less than about 8 inches.

22. The communication device of claim 18 wherein said communication device comprises a radio frequency identification (RFID) tag.

23. The communication device of claim 18 wherein said communication device comprises a radio frequency identification (RFID) reader.

24. A method, comprising:
detecting a wireless signal;
upon detecting said wireless signal, automatically retrieving a location of a fixed position wireless communication device; and
transmitting said location to a mobile wireless communication device.

25. The method of claim 24 wherein detecting a wireless signal comprises detecting a periodic beacon signal.
